(19) United States
(12) Patent Application Publication
(10) Pub. No.: US 2011/0300395 A1
(43) Pub. Date: Dec. 8, 2011

(54) Corrosion Protection System for Offshore Steel Structures and a Method for its Application

(76) Inventors: Hans-Guenter Wobker, Bramsche (DE); Egon Mackowiak, Osnabrueck (DE); Bernd Sagebiel, Dessau-Rosslau (DE); Christoph Meyerrose, Georgsmarienhuette (DE)

(21) Appl. No.: 13/101,729

(22) Filed: May 5, 2011

(30) Foreign Application Priority Data
May 5, 2010 (DE) 10 2010 019 563.4

(51) Int. Cl. H01B 1/02; B23K 9/16; B32B 15/00

(52) U.S. Cl. 428/544; 252/513; 219/74

(57) ABSTRACT

A corrosion protection device (7) as sheathing (8) for a metallic component (3), whose positioning is provided in the effective range of an electrolyte (4) in the form of seawater. According to the present invention, the sheathing (8) is formed of a sheet metal which is connected electrically conductively to the metallic component (3), the sheet metal being made of a metal that is more noble compared to the metallic component (3), and thus has a higher potential. Consequently, the sheet metal as sheathing of the metallic component (3) represents a closed, peripheral jacket of parts of the steel structure (1b).

### CROSS-REFERENCE TO RELATED APPLICATIONS

The present application claims priority to Application No. 10 2010 019 563.4 filed in the Federal Republic of Germany on May 5, 2010, the entire contents of which is expressly incorporated herein in its entirety by reference thereto.

### BACKGROUND OF THE INVENTION

The present invention relates to a corrosion protection system as sheathing for a metallic component, particularly for offshore steel structures, and to a method for its application for producing a corrosion protection system.

Steel structures situated in an offshore region are exposed to extreme corrosion stress. As framework support structures they are situated both above and below water and they require corrosion protection adapted to these circumstances.

Galvanically or mechanically applied coatings are known for this in the related art, which cover the steel material used at least area-wise. Particularly those areas which do not lie under water, or only seldom as well as sporadically, are preferably provided with painted coatings based on synthetic resins. On the other hand, areas that are permanently under water have every reason to be equipped with cathodic protection. For this purpose, known sacrificial anodes and cathodic passivating methods are also suitable. In particular, inaccessibility as well as the rough conditions frequently prevailing in front of the coast make it difficult up to impossible to exchange or renew such corrosion protection measures. Especially the painted coatings used, because of their low mechanical resistance to the abrasive and corrosive stresses that are present, have only a short service life. Up to now, there is no practicable solution for necessary improvements.

All in all, offshore regions are becoming ever more important, not least in view of renewable energy requirements. In connection with wind power systems, for example, periods of application are being planned which assume very long service lives of the materials used. In order to be sufficient for the safety requirements on such constructions, corrosion additions of up to 20 millimeters of the material thickness are being demanded for utilization periods that may last up to 25 years. System planning for clearly longer time spans demand correspondingly greater additions.

On this matter, document DE 26 52 242 A1 describes a device for the protection of construction elements, located in water, from corrosion. Besides the filler blocks that level or geometrically simplify the occasionally irregular cross sections of the construction elements, the crux of the design approach is an enveloping foil that radially surrounds the construction element and is closed in on itself. The filler blocks are preferably connected to the construction element via a water and air-tight adhesive. The peripheral enveloping foil itself is radially stretched out via rod elements located at their longitudinal edges and aligned in the longitudinal direction. Between the rod elements, as well as the upper and lower edge regions of the enveloping foil and the filler blocks, elastic neoprene seals are inserted, for example. All in all, this yields a corrosion protection sheathing which protects the construction element in a plurality of places. In this manner, there is created a device that is cost-effective and is able to be used in above and below water regions for the protection of construction elements against corrosion. However, there is room for improvement in the enveloping foil in the form of a plastic foil that is easily damaged by the effects of UV ageing and mechanically, for instance, by flotsam.

### SUMMARY OF THE INVENTION

It is an object of the invention to improve a corrosion protection system for steel structures in the offshore region in such a way that the sheathing used has great resistance to ageing and mechanical effects.

According to the present invention, a corrosion protection system is created as sheathing for a metallic component, the positioning of the metallic component in the effective range of an electrolyte being provided. When the metallic component is used in an offshore structure in the open ocean, off the shore, the electrolyte corresponds to seawater, which has an increased electrical conductivity compared to fresh water. Depending on the metallic material used, its tendency to go into solution within the electrolyte differs. Independently of whether the metallic component is entirely surrounded by the electrolyte, or is only wetted by it from place to place, the oxygen dissolved in it is used as a means of oxidation and forms oxides in combination with water and the metallic material. According to the present invention, the sheathing of the metallic component is formed of sheet metal, which is connected to the metallic component in an electrically conductive manner. The sheet metal, made up of a metal, is nobler compared to the metallic component, and consequently has a higher potential. The metallic component is sheathed by the sheet metal in regions that have a high concentration of means of oxidation. In the effective range of the electrolyte this occurs in the spray water zone which is located in the vicinity of the highest state of the sea level, as well as in the transition zone that is to be found in the range between the lowest level and the underwater region. Because of the higher potential of the sheet metal compared to the metallic component, its endeavor to go into solution within the electrolyte is less. This yields a higher resistance to corrosion compared to the metallic component.

### BRIEF DESCRIPTION OF THE DRAWINGS

The present invention is described in detail below, using an exemplary embodiment represented schematically in the drawings. The figures show:

FIG. 1 a view of an unprotected steel structure that is anchored in the seafloor and projects above the highest water level;

FIG. 2 a variant of the steel structure shown in FIG. 1, in the same manner of illustration, having a corrosion protection system according to the present invention;

FIG. 3 in a cut manner of representation, a cutout of the corrosion protection system according to the present invention in a connection rgion;

FIG. 4 a connection arrangement, as variant in a manner of representation according to FIG. 3 and

FIG. 5 a further variant of the connection arrangement according to the manner of representation of FIGS. 3 and 4.

### DETAILED DESCRIPTION OF THE INVENTION

The alloy of the sheet metal is preferably made more noble in that it has at least 5 percent nickel. Within the electromotive series, compared to the metallic material of steel, nickel lies clearly closer at the cathodic end, whereby the stability to corrosion is increased.

In order to achieve as corrosion-resistant an alloy for the sheet metal as sheathing of the metallic component, it is made more noble in that the sheet metal has a proportion of nickel of 9 to 30 percent. The corrosion-resistance of the sheet metal used increases with an increasing proportion of nickel.

According to the present invention, the sheet metal used for the sheathing is connected to the metallic component, that is to be protected from corrosion, via a welding seam. An electrically conductive connection is created by the welding seam.

In order particularly to protect the welding seam against corrosion attack, it is provided that it have a proportion of nickel from 25 to 95 percent.

The sheet metal used for the sheathing preferably has a thickness of 2 to 6 millimeter. Particularly in the case of metallic components that are irregular in cross section, occasionally larger areas have to be bridged using the sheet metal. In order to achieve an appropriate mechanical resistance capability, thicker sheet metals are used for this, while in areas having more planar overlays on the metallic component, one may fall back on a thinner, and therefore more cost-effective sheet metal.

It is provided that the sheathing made of sheet metal is a closed peripheral jacket of the metallic component. For this purpose, for instance, the welding seams are executed in such a way that the sheathing of sheet metal yields a cladding, radially as well as at the ends lying in the longitudinal direction of the metallic component, that is closed in on itself and sealed from the electrolyte.

In addition, by the choice of a suitable alloy of the sheet metal, a marine growth-inhibiting effect of the corrosion protection system is achieved.

The sheet metal used, in an advantageous manner, has the following composition:
nickel (Ni) 9 to 11%
iron 1.0 to 2.0%
manganese (Mn) 0.5 to 1.0%
carbon (C): maximum 0.05%
lead (Pb): 0.01 to 0.02%
sulfur (S): 0.005 to 0.02%
phosphorus (P): maximum 0.02%
zinc (Zn): 0.05 to 0.5%
The remainder is copper (Cu) including contaminations conditioned upon smelting procedure.

This optimizes those properties of the sheet metal which favor the stability to corrosion.

According to the present invention, the metallic component is formed of one of the following fine-grained structural steels having a yield strength of 275 to 550 MPa. For this purpose, the following types of steel are used: S275N, S355N, S420N, S460N, S500Q in each case (DIN EN 10025).

In order to produce a corrosion protection system as sheathing for a metallic component, whose positioning is provided to be in the effective range of an electrolyte, the present invention provides that the sheathing of sheet metal be connected to the metallic component in a continuous material manner. Besides the connection, that is thus electrically conductive, between the sheet metal and the metallic component, a peripherally tight connection is thus created between the sheathing and the sheathed metallic component with respect to the electrolyte. A durable and maintenance-free connection is also achieved with respect to mechanical stresses.

In the production of the sheathing, it is provided that the sheet metal be welded to the metallic component under an appropriate protective atmosphere. The protective gas atmosphere for this is set according to ISO14175-13-ArHe-50. The welding seam thus created has a great resistance to corrosion, since none of the oxygen driven off by the noble gas is included.

The corrosion protection system has a very great stability in response to mechanical stresses, and is particularly insensitive to impinging flotsam. The selection of the sheet metal, whose alloy has a high proportion of copper and nickel, stands out because of its great resistance to corrosion. Even with regard to continually enduring mechanical stresses by abrasion, which may be created, for instance, by sediments located in the seawater and loosened suspended material, in contrast to the usual protective coatings or enveloping foils, a clear advantage comes about with respect to the stability of the sheathing used. In addition, the sheathing used is environmentally neutral and completely reusable.

The electrically conductive connection between the sheet metal and the metallic component, which demonstrates a potential difference between the properties of the materials used, is selected, in this instance, locally in the regions which do not allow the creation of a galvanic cell as means of oxidation in connection with water and oxygen. Thus the redox reaction, that is otherwise desired in response to the use of sacrificial anodes, does not come in useful here. Thus, the upper end of the sheet metal, as of which the metallic component no longer has a sheathing, lies above the region of the spray water zone, in which no galvanic cell is able to develop. Within the transition zone, which has a great supply of means of oxidation in the form of dissolved oxygen, the metallic component is protected from contact corrosion by the sheathing that is closed in on itself, as an anode. The oxygen supply, that drops off in the direction towards the underwater zone, has the effect that the region of the transition zone and the spray water zone is anodic with respect to the underwater zone, whereby the electrochemical potential of this region with respect to one and the same material becomes less noble in the underwater region. Because of the high potential of the sheet metal used for the sheathing in combination with the electrically conductive connection to the metallic component via welding seams, this effect leads to a uniform electrochemical potential between the transition zone, that is sheathed with sheet metals, and the underwater region, in which the metallic component has no sheathing. The development of a galvanic cell is thereby not possible, or only very slightly so, so that galvanic corrosion is hardly possible.

The corrosion protection system, that is provided with a drastically reduced susceptibility to repairs, compared to other usual systems, does not require an otherwise usual extra corrosion addition, so that, all in all, an exceptionally maintenance-friendly system is created and one that is economical to set up.

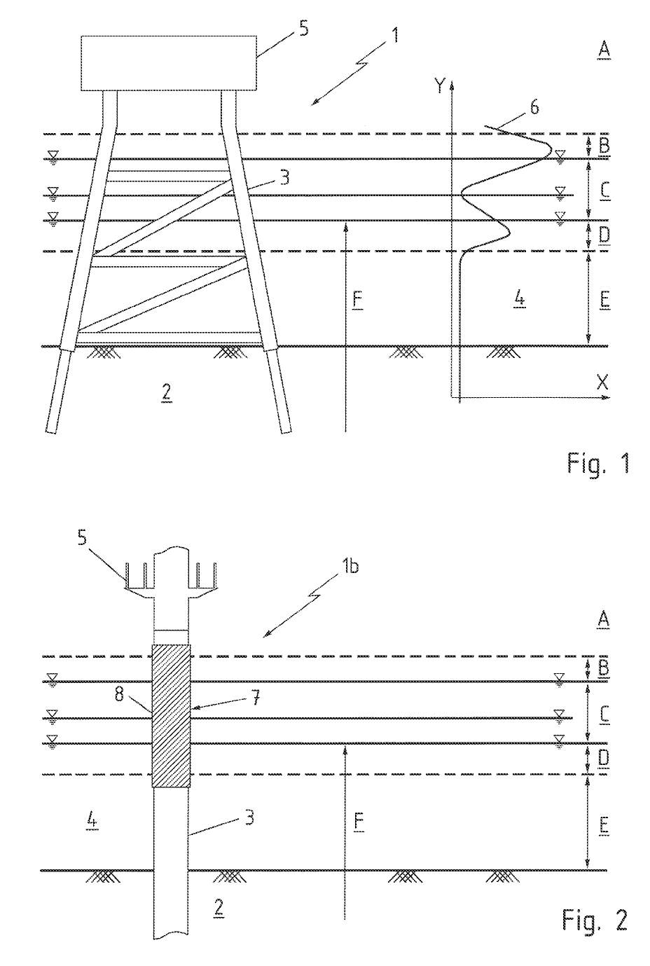

FIG. 1 shows an unprotected steel structure 1, which is anchored in a region of seafloor 2. Steel structure 1 has a plurality of supports and horizontal and diagonal members connecting them, of which each is formed of a metallic component 3. Steel structure 1 extends over the highest level of an electrolyte 4, in the form of seawater, into an atmosphere A filled with air, where it acts as a framework support structure for an installation 5, that is not specified in greater detail. Starting from atmosphere A, and going in the direction of seafloor 2, the layering of electrolyte 4 in the form of seawater subdivides into a spray water zone B, a tidal zone C, a transition zone D and a submerged zone E. In this instance, transition zone D, together with submerged zone E, forms a common underwater zone F.

Furthermore, FIG. 1 shows a graph 6 within a coordinate system that is aligned parallel to steel structure1. The abscissa is used, in this case, to give a loss in thickness X of metallic component 3, the ordinate showing a depth position Y of metallic component 3 within electrolyte 4 in the form of seawater. In this instance, graph 6 shows qualitatively the corrosion attack created over time of metallic component 3 in response to an unprotected construction method, which runs differently over the individual zones B to E. The greatest loss in thickness X of metallic component 3 is accordingly in spray water zone B and in transition zone D. Tidal zone C, on the average, together with submerged zone E demonstrates the smallest loss in thickness X of metallic component 3.

FIG. 2 represents a variant of steel structure 1 shown in FIG. 1. A steel structure 1b, also anchored in seafloor 2, is formed in this case of a metallic component 3 that is compact and formed to form a column-shaped support. In a region between spray water zone B and transition zone D, metallic component 3 is surrounded with a corrosion protection system 7, according to the present invention, in the form of a peripherally closed sheathing 8. In this instance, sheathing 8 extends upwards and downwards beyond the region that was stated, into atmosphere A as well as submerged zone E.

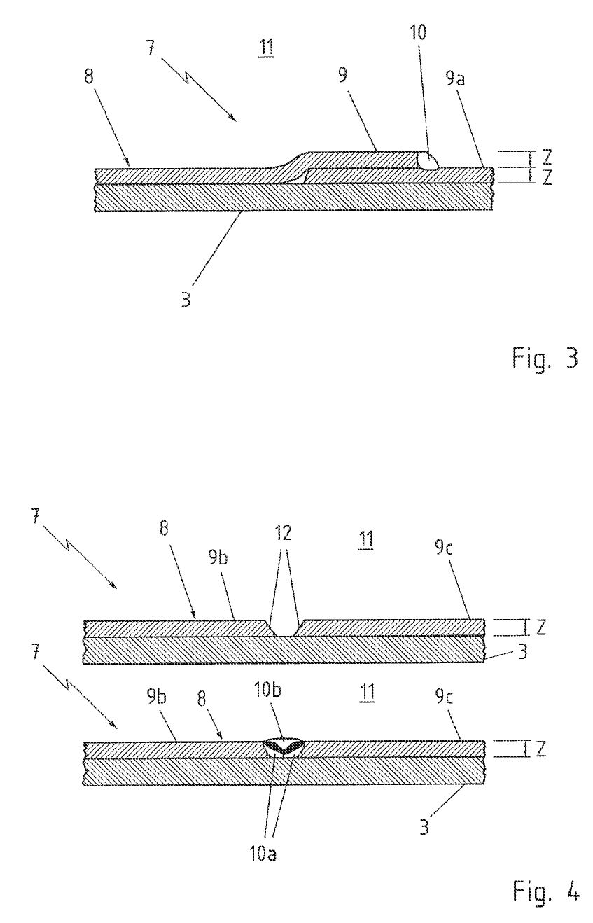

FIG. 3 shows corrosion protection system 7 according to the present invention, which lies upon metallic component 3 from sheathing 8 in the form of a sheet metal 9. Since sheathing 8 cannot take place seamlessly, the connection of sheet metal 9 to an additional sheet metal 9a is pointed out here. In the butt joint area between sheet metals 9, 9a, sheet metal 9 has an upward bending, so that a subregion of sheet metal 9 lies on sheet metal 9a in parallel, as an overlapping. The two sheet metals 9, 9a are connected to each other as continuous material via a welding seam 10. Welding seam 10 was drawn under a protective gas atmosphere 11, in this instance, as connection between sheet metal 9, 9a. In this instance, sheet metal 9, 9a have the same thickness Z.

FIG. 4 shows a variant in the connection of sheet metals 9, 9a of sheathing 8 shown in FIG. 2 as corrosion protection system 7 of metallic component 3. In this case, a sheet metal 9b lies on metallic component 3, while an additional sheet metal 9c also lies on metallic component 3 and is at a distance from sheet metal 9b. Thus, the ends of sheet metals 9b, 9c that lie opposite to each other in a plane each have a bevel 12, whereby the distance between sheet metals 9b, 9c opens V-shaped towards a side facing away from metallic component 3. In a follow-up representation of FIG. 3, sheet metals 9b, 9c are shown connected together with metallic component 3. For this purpose, respective bevel 12 of sheet metals 9b, 9c is first connected to metallic component 3, in a continuous material manner, via a welding seam 10a, that is formed under a protective gas atmosphere 11. The remaining space between sheet metals 9b, 9c is filled up in a next step, by an additional welding seam 10b, within protective gas atmosphere 11.

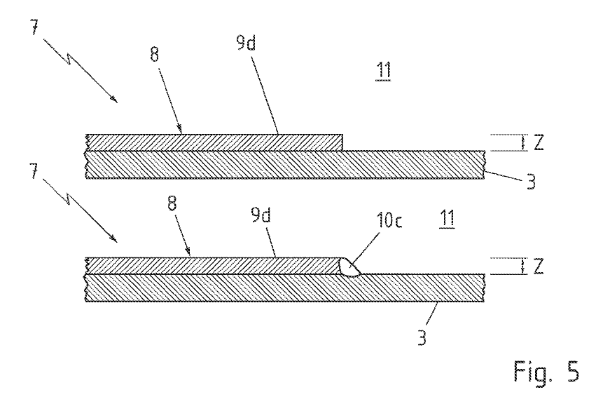

FIG. 5 shows a simple connection of a sheet metal 9d that is situated flat on metallic component 3. After the planar overlay of sheet metal 9d onto metallic component 3, sheet metal 9d is connected in a continuous material manner to metallic component 3 via a welding seam 10c under protective gas atmosphere 11.

In practice, a steel structure 1, situated in the offshore region, which is anchored within an electrolyte 4 in the form of seawater in a region of seafloor 2, is protected by a corrosion protection system 7 according to the present invention. The individual elements of steel structure1 1 are each formed by a metallic component 3 that is to be protected, in this case. Because of the large supply of means of oxidation in the form of dissolved oxygen, particularly within a spray water zone B and a transition zone D of electrolyte 4, the metallic component located in them is especially stressed by corrosion.

These regions, in particular, are protected using a corrosion protection system 7, metallic component 3 being jacketed in this instance by a peripheral sheathing 8 that is closed in on itself. Sheathing 8 is made up in this case of sheet metal 9, 9a to d, which is connected in an electrically conductive manner to metallic component 3 via a welding seam 10a, 10c. Sheet metals 9, 9a to c are connected to one another via a welding seam 10, 10b, in this instance.

Sheathing 8 is nobler, with respect to the material used, than metallic component 3, whereby sheathing 8 has a higher potential. The alloy of sheathing 8 has a high resistance to corrosion within the effective range of electrolyte 4, in the form of seawater. Depth position Y of sheathing 8 within electrolyte 4 is selected, in this instance, so that, between sheet metal 9, 9a to 9d and metallic component 3, in combination with water and oxygen of electrolyte 4, no galvanic cell is created.

All in all, there consequently comes about a sheathing 8 of metallic component 3 of steel structure 1 that is highly stable, which, in addition, because of the selection of its metallic material, has a great mechanical ability to be stressed by abrasion and impact, as well as by ageing, such as by UV radiation. Corrosion protection system 7, thus created, enables an economical and maintenance-friendly operation of offshore installations, especially in view of running times that are longer and becoming ever longer.

### LIST OF REFERENCE NUMERALS

1 steel structure
1b steel structure
2 seafloor
3 metallic component
4 electrolyte
5 installation
6 graph
7 corrosion protection system
8 sheathing
9 sheet metal
9a sheet metal
9b sheet metal
9c sheet metal
9d sheet metal
10 welded seam
10a welded seam
10b welded seam
10c welded seam
11 protective gas atmosphere
12 bevel
A atmosphere
B spray water zone
C tidal zone
D transition zone
E submerged zone
F under water zone
x thickness lost by 3 in response to unprotected manner of construction
Y depth position of 3
Z thickness of 3

What is claimed is:

1. A corrosion protection system as sheathing (8) for a metallic component (3), whose positioning is provided in the effective range of an electrolyte (4),
wherein the sheathing (8) is formed of a sheet metal (9, 9a-d) which is connected electrically conductively to the metallic component (3), the sheet metal (9, 9a-d) being made of a metal that is more noble compared to the metallic component (3).

2. The corrosion protective system as recited in claim 1, wherein the sheet metal (9, 9a-d) is formed from an alloy which has copper and at least 5 wt.-% nickel.

3. The corrosion protection system as recited in claim 1, wherein the sheet metal (9, 9a-d) has a proportion of nickel of 9 wt.-% to 30 wt.-%.

4. The corrosion protection system as recited in claim 1, wherein the sheet metal (9, 9a-d) is connected to the metallic component (3) via a welding seam (10a, 10c).

5. The corrosion protective system as recited in claim 4, wherein the welding seam (10, 10a-c) has a proportion of nickel of 25 to 95 wt.-%.

6. The corrosion protection system as recited in claim 1, wherein the sheet metal has a thickness of 2 to 6 millimeters.

7. The corrosion protection system as recited in claim 1, wherein the sheathing (8) made of sheet metal (9, 9a-d) is a closed peripheral jacket of the metallic component (3).

8. The corrosion protection system as recited in claims 1, wherein the sheet metal (9, 9a-d) has the following composition:
nickel (Ni) 9 to 11%
iron 1.0 to 2.0%
manganese (Mn) 0.5 to 1.0%
carbon (C): maximum 0.05%
lead (Pb): 0.01 to 0.02%
sulfur (S): 0.005 to 0.02%
phosphorus (P): maximum 0.02%
zinc (Zn): 0.05 to 0.5%
The remainder is copper (Cu) including contaminations conditioned upon smelting procedure.

9. The corrosion protection system as recited in claim 1, wherein the metallic component (3) is formed of fine-grained structural steel having a yield strength of 275 to 550 MPa.

10. The corrosion protection system as recited in claim 1, wherein the sheathing (8) is made of a marine growth-inhibiting material.

11. A method for producing a corrosion protection system according to claim 1, comprising connecting the sheathing (8) in a continuous material manner to the metallic component (3).

12. The method as recited in claim 11,
wherein the sheet metal (9b-d) is welded to the metallic component (3) under a protective gas atmosphere (11).
